(19) United States
(12) Patent Application Publication
(10) Pub. No.: US 2013/0255341 A1
(43) Pub. Date: Oct. 3, 2013

(54) METHOD FOR HEATING A METAL SLAB

(71) Applicants: Tomas EKMAN, Saltsjo-Boo (SE); Rudiger EICHLER, Taby (SE)

(72) Inventors: Tomas EKMAN, Saltsjo-Boo (SE); Rudiger EICHLER, Taby (SE)

(21) Appl. No.: 13/845,649

(22) Filed: Mar. 18, 2013

(30) Foreign Application Priority Data
Mar. 27, 2012 (EP) 12002195.1

(51) Int. Cl. F27B 9/36; B21B 37/74; F27D 3/00

(52) U.S. Cl. CPC F27B 9/36; F27D 3/0024; B21B 37/74
USPC 72/202; 432/6; 432/11; 432/19; 432/1

(57) ABSTRACT

A method for heating a metal slab being transported in a longitudinal direction (L) and having a cross-direction (T) through an industrial furnace in which the metal slab is heated and transported on a rail device from the industrial furnace for subsequent processing, includes impinging a flame from at least one direct flame impingement (DFI) burner to contact a first portion of a first surface of the metal slab in at least one location corresponding to a second position on an under side surface of the metal slab which during transporting of the metal slab through the industrial furnace constitutes a contact point between the under side surface of the metal slab and the rail device, and counteracting a temperature gradient in the metal slab arising from local cooling of the metal slab upon contact with the rail device by heating the first portion with the DFI burner.

The present invention relates to a method for heating a metal slab or other similar blanks such as a metal bloom, which is heated in an industrial furnace.

When heating metal slabs, that typically have a considerable weight, there are problems with long heating times. Since the thermal energy supplied to the slab must go through the surface of the slab, the risk of overheating of this surface puts a limit on how quick the slab can be heated. Since each metal slab often represents large economic values, it is desirable to exercise great caution during the heating in order to avoid such overheating.

Conventionally, the heating takes place in continuous pusher—or walking beam furnaces, whereby metal slabs are transported and heated. Before a subsequent machining step, such as rolling, the slabs are normally transported through and out of the furnace using a rail system supporting the slabs. Since the contact between the slab and the rails or skids thus locally cools the under side of the slab, so-called “skid marks” often arise on the finished product. This is not desirable, since the final material properties of the product will then not be homogenous.

The present invention solves the above described problems.

Thus, the invention relates to a method for heating a metal slab which is transported in a longitudinal direction, vertically to a cross-direction, through an industrial furnace, in which the metal slab is heated, which metal slab is then transported on a rail device out from the industrial furnace to a subsequent processing step, and is characterised in that the flame from at least one DFI (“Direct Flame Impingement”) burner is caused to impinge upon a part of a first surface of the metal slab in at least one location which corresponds to a point on the under side surface of the metal slab which, during the passage of the metal slab through the industrial furnace, has constituted, constitutes or will constitute a contact point between the under side surface of the metal slab and the rail device, and in that a temperature gradient in the metal slab, which arises as a consequence of the local cooling of the metal slab through the contact with the rail device, therefore is counteracted by the local heating using the DFI burner.

### BRIEF DESCRIPTION OF THE DRAWINGS

In the following, the invention will be described in detail, with reference to exemplifying embodiments of the invention and to the appended drawings, where:

FIG. 1a is a cross-sectional side view of an industrial furnace, in which a first method according to the present invention can be applied;

FIG. 1b is a cross-sectional top view of the industrial furnace of FIG. 1a;

FIG. 2a is a cross-sectional side view of an industrial furnace, in which a second method according to the present invention can be applied;

FIG. 2b is a cross-sectional top view of the industrial furnace of FIG. 2a;

FIG. 3a is a cross-sectional side view of an industrial furnace, in which a third method according to the present invention can be applied; and

FIG. 3b is a cross-sectional top view of the industrial furnace of FIG. 3a;

All Figures share reference numerals for corresponding parts.

### DETAILED DESCRIPTION OF THE INVENTION

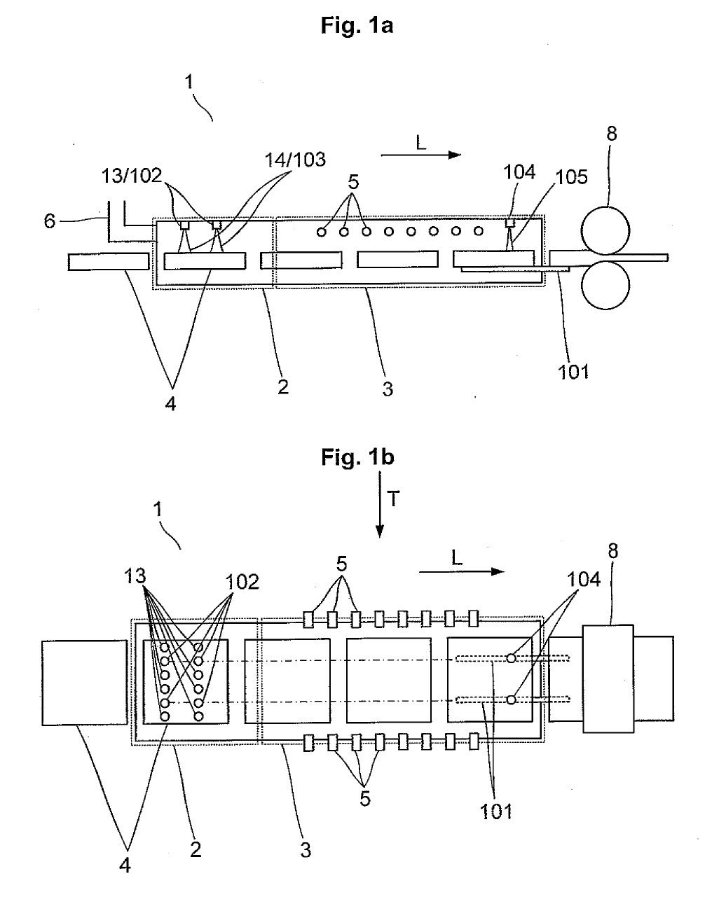

FIGS. 1a and 1b show an industrial furnace 1 for heating of metal slabs 4 made of, for example, steel, from a certain initial temperature, such as room temperature, to a final temperature before a subsequent processing step. The final temperature can be for instance, for certain steel types, between 1250° C. and 1300° C.

The heating takes place in at least two zones, comprising a heating zone 2 and a temperature equalizing zone 3, in the Figures shown using dotted lines. In the heating zone 2, the metal slabs 4 are heated relatively fast to a temperature profile at which the surface of the metal slabs 4 essentially keeps the desired final temperature but their cores are cooler. In the temperature equalizing 3, an essentially homogenous temperature profile is then achieved in the whole slab, using additional heating. Each metal slab 4 is thus transported in a longitudinal direction L through the furnace 1, first through the heating zone 2 and thereafter through the temperature equalizing zone 3.

The temperature equalizing zone 3 is heated by a series of conventional burners 5, such as for example conventional air burners, for instance mounted in the side wall of the furnace 1, and/or in the roof in the form of conventional burners of so-called “disc” type, giving rise to a flame with a large spread angle. The combustion gases from the burners 5 flow in a counter-current direction, through the heating zone 2 and out through a chimney 6 arranged in or upstream of the heating zone 2.

The furnace 1 is suitably a continuous walking beam—or pusher furnace. The metal slabs 4 are suitably at least 10 cm thick, rather at least 20 cm thick. Moreover, the metal slabs are each suitably between 50 and 200 cm wide and between 5 and 20 meters long.

At the end of the temperature equalizing zone 3, the metal slabs 4 are transported on an, in itself conventional, water cooled rail device 101, comprising skids out from the furnace 1 and to a subsequent processing step 8, in the figures exemplary illustrated as a rolling step.

According to the invention, at least one DFI (“Direct Flame Impingement”) burner 102 is arranged so that its flame 103 impinges against a part of the surface of the metal slab 4 in at least one location which corresponds to a point on the under side surface of the metal slab 4 which, during the passage of the metal slab 4 through the industrial furnace has constituted, constitutes or will constitute a contact point between the under side surface of the metal slab 4 and the rail device 101. That the location on the surface of the metal slab 4 “corresponds to” an earlier, present or to-be contact point with the rail device is to be interpreted so that the location on the surface of the metal slab 4 is located on the upper side surface or under side surface of the metal slab 4, and that the location in question during the passage through the industrial furnace of the metal slab 4 at least at one time overlaps with the vertical projection of the contact surface between the under side surface of the metal slab 4 and the rail device 101, before, at the same time as or after the flame 103 impinges against the surface of the metal slab 4. The point at which the flame 103 impinges against the metal slab 4 is thus located right across from the corresponding location on the under side surface of the metal slab 4, which then has constituted, constitutes or will constitute a contact point with the rail device 101.

Since the DFI burner 102 thus supplies thermal energy locally to said location on the surface of the slab 4, this location will be heated. By thermal conduction, the supplied thermal energy will also lead to an area at and around said point on the upper or lower surface of the slab locally and will assume a somewhat higher temperature than the surrounding material in the slab 4. Hence, this heating takes place locally in the main plane of the metal slab 4, the axes of which are constituted by the arrows L and T as illustrated in the Figures, and the achieved temperature gradients are determined by the thermal conduction through the slab 4.

According to the invention, the local heating by the DFI burner 102 thereby counteracts a temperature gradient in the metal slab 4, which arises as a consequence of the local cooling of the metal slab because of the contact with the rail device 101. Ideally, these two temperature gradients will cancel each other out completely, but in practice the gradient arisen because of the heating will decrease the effects of the cooling-induced gradient only to some extent.

Moreover, by this counteraction of the local cooling caused by the rail device 101, the initially mentioned problem of “skid marks” is decreased or eliminated. It is preferred that the DFI burner 102 is designed so that the extent of the local heating of the upper or lower surface of the slab 4 which is achieved by the flame 103 essentially counterbalances the local cooling taking place as a consequence of the contact with the rail device 101.

It is essential that the burner 102 is a DFI burner, in order to be able to achieve the above described heating, which is only local. It is preferred, albeit not necessary, that the flame 103 is so narrow so that the largest diameter of the part of the surface of the slab 4 against which the main part of the flame 103 impinges essentially is no larger than the width of the contact surface between the slab 4 and the rail device 101.

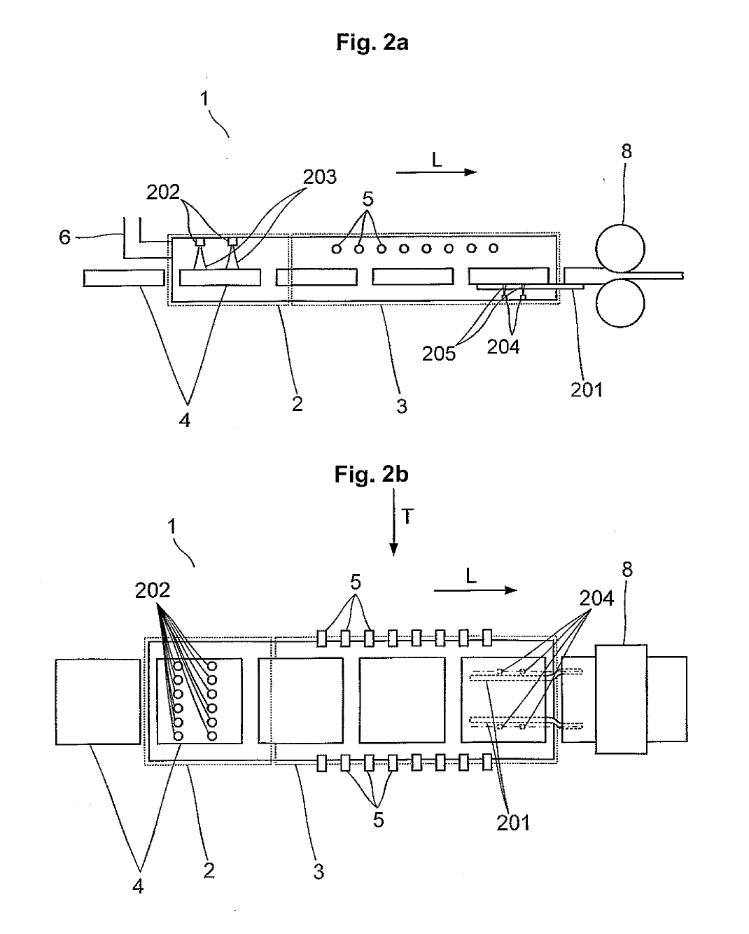

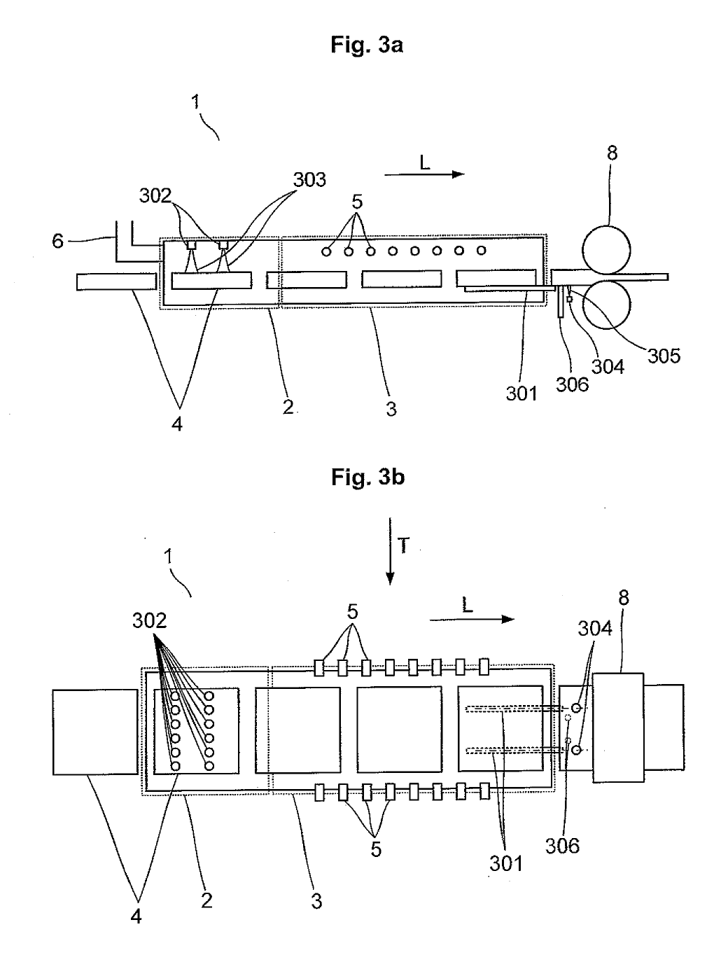

According to a preferred embodiment, the DFI burner 102 is stationary in the furnace 1, and the metal slab 4 is arranged, during its passage through the furnace 1, to pass below the DFI burner 102. In this case, it is further preferred that the flame 103 impinges against the upper side surface of the slab 4 at a location which is located vertically above a point on the lower side of the metal slab 4 which has constituted, constitutes or will constitute a contact point between the metal slab 4 and the rail device 101. In FIG. 1b, as well as correspondingly in FIGS. 2b and 3b, this is illustrated with dashed and dotted lines, showing the passage way through the furnace 1 of two different points on the upper side of a slab. Both points pass from a first respective DFI burner 102 and on to the location for a respective skid of the rail device 101.

With such arrangement, large freedom is achieved regarding where in the longitudinal direction L of the furnace 1 to position the DFI burners 102.

Furthermore, it is preferred, in connection to the just described preferred embodiments, that the flame 103 of the DFI burner 102 is caused to have an elliptical cross-section, the major axis of which is longer than its minor axis and parallel to the longitudinal direction L. Such a flame can for instance be achieved using a DFI burner of the “pipe-in-pipe” type, where concentric orifices for oxidant and fuel each are elliptical, and achieves that a larger amount of thermal energy can be delivered to the slab 4 of each DFI burner 102, without the heated surface being too wide in the cross-direction L, so that the cooling locally achieved by the skids is overcompensated.

It is preferred, as is illustrated in the Figures, that all contact points, along the cross-direction T, between the metal slabs 4 and the rail device 101, such as all skids of the rail device 101, are preheated using a respective DFI burner 102 in accordance with the above described. In other words, for each contact point between the slab 4 and the rail device 101 along the cross-direction T, a respective DFI burner 102 is caused to be arranged so that its respective flame 103 impinges against the upper side surface of the slab 4 at a respective location which is located vertically above a respective point on the under side surface of the slab 4 which constitutes or will constitute the contact point between the under side of the slab 4 and the rail device 101.

In the Figures, two longitudinal rows of DFI burners 102 are illustrated, each comprising two DFI burners which are both arranged to heat the same spot on the upper side of each slab 4 when the slab in question passes under firstly the first and then the second DFI burner. It is realized that only one DFI burner per contact surface between the slab 4 and the rail device 101 can also be used, even if it is preferred to use at least two, more preferably several DFI burners 102 per such contact point, since this makes it possible to heat in a pulsing manner each respective location on the upper side of the slab 4 when the slab 4 is moving in the longitudinal direction L past several repeatedly arranged DFI burners 102. Namely, in this latter case, more thermal energy can be delivered to the interior of the slab 4, without the surface risking overheating, since the surface will have time to cool down somewhat between DFI burners.

Moreover, the DFI burners 102 are arranged so that their respective flames 103 impinge against the slabs 4 at a location upstream of the rail device 101, more precisely in the heating zone 2. In the heating zone 2, the surface temperature of the slabs 4 is still essentially lower than what is the case in the temperature equalizing zone 3, where higher power can be used without risking overheating, and where a faster thermal transfer can be achieved. According to a preferred embodiment, all burners in the heating zone 2 are DFI burners, which by allowing their respective flames to impinge against the surface of the slabs 4 quickly heats the slabs to the required temperature profile before the temperature equalizing zone 3.

In order to achieve sufficient power, to the DFI burners 101 can advantageously be supplemented with additional DFI burners 13, the flames 14 of which are arranged to impinge against the surfaces of the slabs 4 at other locations along the direction T than the DFI burners 102. In this case, it is important that the above described, local heating of the locations heated by the flames 103 of the DFI burners is more powerful than the corresponding heating of other locations on the surface of the slabs 4, in order to achieve the above described counteraction of “skid marks” on the surface of the finished product.

It is preferred that such possible supplementary DFI burners 13 are driven with an oxidant comprising at least 85% oxygen, rather at least 95% oxygen, and that this oxidant is supplied at a velocity of at least 200 m/s, rather Mach 1, most preferably Mach 1.5. This will create, by heavy turbulence, so-called “flameless” combustion, in which no visible flame is present, which in turn decreases local temperature gradients on the surface of the slab 4 as a consequence of the heating with the supplementary DFI burners 13.

As a complement to or in addition to the DFI burners 102, DFI burners 104 can also be arranged so that their respective flames 105 impinge against the respective upper sides of the slabs 4 at a location above the rail device 101, so that the heated part of the under side of the slab 4 has already been in contact with the rail device 101 when the corresponding location on the upper side of the slab 4 is reached by the flame 105.

In order to achieve high power and local heating of a precise and well-defined part of the upper side surface of the slab 4, it is preferred that the DFI burners 104 are driven with an oxidant comprising at least 85% oxygen, rather at least 95% oxygen.

FIGS. 2a, 2b and 3a, 3b, respectively, illustrate further preferred embodiments, in which DFI burners 204 or 304, respectively, are stationary in relation to the industrial furnace 1, in such a way so that their respective flames 205, 305 impinge against the under side surface of the metal slab 4 from below. In a way which is analogous to the above described, the flames 205, 305 impinge against the surface of the metal slab 4 at a location, which in the cross-direction T corresponds to the location at which a contact point between the metal slab 4 and the rail device 201 or 301, respectively, has been or will be arranged.

In accordance with FIGS. 2a, 2b, the rail device 201 comprises one or several skids, which are arranged to support the slab 4, whereof at least one skid is bent or otherwise arranged obliquely in relation to the longitudinal direction L as shown in FIG. 2b, so that the contact surface formed between the under side of the metal slab 4 and the skid is located with different displacement in the cross-direction T along the longitudinal direction L. Thus, the skid in question will locally cool the slab 4 at different positions in the direction T when the slab 4 moves forward in the direction L in relation to the skid.

This will result in that at least one DFI burner 204 can be stationary in the furnace 1 and so that its flame 205 impinges against the under side surface of the metal slab 4 from below at a location which has been or will be in contact with the skid. In FIGS. 2a and 2b, the burners 204 are arranged so that they locally heat a location on the under side surface of the slab 4, which later will come into contact with the rail device 201 when this widens in the end part of the furnace 1. It is realized that the rail device 201 in a corresponding way can be arranged to narrow down or be parallel displaced in the direction T. It is also realized that the skid just as well can be arranged to widen out, narrow down or in any other way be displaced in the direction T well before the end part of the furnace 1, and that DFI burners in this case can be arranged downstream of said displacement. In the latter case, such DFI burners will thus heat a location which has previously been in contact with the skid.

As is clear from FIGS. 2a, 2b, these burners 204 can be used in combination with DFI burners 202 and associated flames 203 of the type described above, with high lancing velocities and oxygen contents, in order to quickly heat the slab 4 in the heating zone 2.

FIGS. 3a and 3b illustrate a further preferred embodiment, in which a discharge device is arranged to unload the metal slab 4 from the industrial furnace 1, from its position on the rail device 301 to some other type of transport system for further transport to the rolling step 8. The unloading can also involve a directional change of the route of the slab 4.

The discharge device comprises contacting means 306 in the form of claws, forks or the like, arranged to, during unloading, support the metal slab 4 from below, at locations which are arranged so that they do not, in the cross-direction T, overlap the downstream end of the skids of the rail device 301 which are supporting the metal slab when it leaves the rail device 301. This may, for example, be achieved by the contact means 306 being arranged with narrower, such as shown in FIG. 3b, or wider space than what is the case with the skids of the rail device 301 at the end part of the furnace 1.

Finally, at least one DFI burner 304 is stationary downstream of the end part of the industrial furnace 1 and in the prolongation of at least one skid of the rail device 301 at a location, which in the cross-direction T corresponds to that of the downstream termination of this skid. The flames 305 from DFI burners 304 are arranged to impinge against the under side surface of the metal slab 4 at this location, whereby the local cooling achieved by the skid is counteracted as described above.

Also in this embodiment, DFI burners 302 with respective flames 303 can advantageously be used for rapid heating in the heating zone 2.

Above, preferred embodiments have been described. However, it is apparent to the skilled person that many modifications can be made to the described embodiments without departing from the basic idea of the invention.

For example, the embodiments illustrated in FIGS. 1a, 1b; 2a, 2b; and 3a, 3b, respectively, can advantageously be combined, such as to use both burners of the type shown in FIGS. 1a and 1b, the flames of which heat the upper side of the slab, and burners of the type shown in FIGS. 2a, 2b and/or 3a, 3b, the flames of which heat the under side of the slabs. Depending on the specific operational conditions, the negative effects of the local cooling of the skids may be counteracted stepwise.

Furthermore, the rail device on which each slab is transported can be designed in many different ways, of which the variants illustrated in the Figures are intended to be exemplary.

The subsequent processing step does not need to be a rolling step, or an additional, intermediate processing step can be present between the furnace and a rolling step.

Moreover, more zones than the above described heating—and temperature equalizing zones can be used in the furnace, which also does not necessarily need to be of a countercurrent type.

Thus, the invention shall not be limited to the described embodiments, but is variable within the scope of the enclosed claims.

What is claimed is:

1. In a method for heating a metal slab (4) being transported in a longitudinal direction (L) and having a cross-direction (T) through an industrial furnace (1) in which the metal slab is heated and transported on a rail device (101;201;301) from the industrial furnace for subsequent processing (8), the improvement comprising: impinging a flame (103,105,205,305) from at least one direct flame impingement (DFI) burner (102,104,204,304) to contact a first portion of a first surface of the metal slab in at least one location corresponding to a second position on an under side surface of the metal slab which during transporting of the metal slab through the industrial furnace constitutes a contact point between the under side surface of the metal slab and the rail device, and counteracting a temperature gradient in the metal slab arising from local cooling of the metal slab upon contact with the rail device by heating the first portion with the DFI burner.

2. The method according to claim 1, further comprising maintaining the at least one DFI burner (102,104) in a stationary position in the industrial furnace, and the impinging the flame (103,105) is upon the upper side surface of the metal slab from above at a location vertically above a point on the under side surface of the metal slab which constitutes the contact point between the metal slab and the rail device.

3. The method according to claim 2, further comprising positioning a DFI burner for each contact point between the metal slab and the rail device (101) along the cross-direction T of the first surface, and impinging a respective flame (103) against the upper side surface of the metal slab (4) at a respective location above a respective point on the under side surface of the metal slab which constitutes a respective contact point between the under side of the metal slab and the rail device.

4. The method according to claim 1, wherein the industrial furnace comprises at least one heating zone (2) and a temperature equalizing zone (3) arranged downstream of the at least one heating zone, and the impinging the flame against the first portion of the first surface of the metal slab is in the heating zone.

5. The method according to claim 1, further comprising maintaining the at least one DFI burner (204;304) stationary in relation to the industrial furnace and wherein the impinging the flame (205;305) is against the under side surface of the metal slab from below at a location along said cross-direction (T) corresponding to the contact point between the metal slab and the rail device (201;301).

6. The method according to claim 5, wherein the under side surface comprises a contact surface located between at least one of the skids in the rail device (201) which supports the metal slab (4) and the under side surface of the metal slab (4) along a longitudinal direction of the skid, the contact surface having different displacements along the cross-direction (T), and the flame for the impinging against the under side surface of the metal slab (4) is stationary in the industrial furnace (1).

7. The method according to claim 5, further comprising a discharge device arranged to unload the metal slab (4) from the industrial furnace (1) for the subsequent processing, the discharge device including means (306) for contacting the metal slab, the improvement further comprising arranging the contacting means to support the metal slab (4) during unloading such that the contact means is arranged along the cross-direction (T) and does not overlap with a downstream end of skids of the rail device (301) which support the metal slab (4) when it leaves the rail device (301), and arranging the at least one DFI burner (304) having the flame impinging against the under side surface of the metal slab (4) to be stationary downstream of the industrial furnace (1) and in the prolongation of said skids in the cross-direction (T).

8. The method according to claim 1, wherein the flame (103,105;205;305) comprises an elliptic cross-section, a major axis of which is longer than a minor axis and parallel to the longitudinal direction (L).

9. The method according to claim 1, further comprising operating the at least one DFI burner (102,104;204;304) with an oxidant comprising at least 85% oxygen.

10. The method according to claim 1, wherein the industrial furnace (1) is selected from the group consisting of a continuous pusher furnace and a continuous walking beam furnace.

11. The method according to claim 1, wherein a thickness of the metal slab (4) is at least 10 cm.

12. The method according to claim 1, wherein the subsequent processing step (8) comprises rolling the metal slab.
